(19) United States
(12) Patent Application Publication
(10) Pub. No.: US 2017/0016411 A1
(43) Pub. Date: Jan. 19, 2017

(54) Thermal Compression Engine

(71) Applicant: Gerald J. HERMAN, Manchester, MI (US)

(72) Inventor: Gerald J. HERMAN, Manchester, MI (US)

(21) Appl. No.: 14/848,392

(22) Filed: Sep. 9, 2015

Related U.S. Application Data
(60) Provisional application No. 62/193,808, filed on Jul. 17, 2015.

(51) Int. Cl. F02G 1/057

(52) U.S. Cl. CPC F02G 1/057

(57) ABSTRACT

The Thermal Compression Engine is an external combustion engine using a regenerator to achieve cycle efficiency. The Thermal Compression Engine uses thermal compression (heat addition resulting in pressure rise) rather than mechanical. By alternating flow into a constant volume, of hot and then cold fluid creates pressure rise and fall in the working fluid. This fluctuating pressure generates a reservoir of high, and a reservoir of low pressure fluid. The TCE cycle uses the high and low pressure storage to generate a fluid flow, with expansion through a turbine or other expansion device, to generate power.

### CROSS REFERENCE TO RELATED APPLICATIONS

This application claims the benefit of U.S. Provisional Application No. 62/193,808, filed on Jul. 17, 2015. The entire disclosure of the above application is incorporated herein by reference.

### FIELD

The present disclosure relates to a heat engine and more particularly to a thermal compression heat engine.

### BACKGROUND AND SUMMARY

Typical mechanical heat engines compress a working fluid by mechanical means, add heat to the fluid to add energy, expand the fluid by some mechanical means to extract energy, and then reject the unusable heat. The mechanical energy to compress the fluid needs to be generated by the mechanical expansion of the fluid, in addition to any output work that the engine generates. Since the compression process is a parasitic process, taking energy from that generated by mechanical expansion device, it is extremely important that the compression and expansion device are of as high efficiency as possible.

Disclosed is a thermal compression engine (hereafter sometimes referred to as TCE) that does not perform a mechanical compression of the working fluid. The fluid is compressed or pressurized by raising the temperature of the fluid in a confined volume. This compression process does not come free, but the process is ideally not dependent upon the efficiencies of mechanical devices, only thermodynamic process. In the thermal compression engines simplest implementation alternating flow, into a constant volume, of hot and cold fluid creates pressure rise and fall in the working fluid. The fluctuating pressure generates a reservoir of high and a reservoir of low pressure fluid. The thermal compression engine cycle uses the high and low pressure reservoir to generate a fluid flow, with expansion through a turbine or other expansion device, to create power. A regenerator is used to recover otherwise waste heat and achieve cycle efficiency.

Disclosed is a thermal compression engine consisting of a main loop and an output loop. The main loop fluidly couples, a heat input exchanger, a vessel defining a working volume, a heat rejection exchanger, a reversible blower, and a regenerator configured to store heat. The thermal compression engine further has an output loop, the output loop having a first passage fluidly coupled to the main loop through a first check valve being fluidly coupled to a second vessel defining a high pressure storage, and a expander, the expander being coupled to a third vessel defining a low pressure storage, the low pressure storage regenerator being coupled to an second check valve which is fluidly coupled to the main loop through a second passage.

The TCE is an external combustion engine using a regenerator to achieve cycle efficiency. The TCE use of thermal compression (heat addition resulting in pressure rise) rather than mechanical compression is one of the features that distinguishes the TCE from the Stirling engine.

The advantages that the TCE cycle offers include the following: all the advantages of an external combustion engine (and disadvantages, of course); high efficiency is possible; most of the engine consists of static structure; in large sizes turbine components can be used and they scale nicely in those large sizes; multiple main loop units can be teamed up together, while only requiring one power extraction device; moving components can be kept at low temperatures while still maintaining good efficiency; and almost silent operation. The cycle has few moving parts, and consists mainly of static structure and emits very low noise during operation.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a mechanical power producing thermodynamic cycle referred to as the TCE (Thermal Compression Engine) cycle;

FIG. 2 shows a figurative pressure vs temperature curve which seems to be most descriptive of the TCE cycle;

FIG. 3 shows a TCE as reduced to practice;

FIG. 4 shows the approach to using multiple main loops with a single output loop;

FIG. 5 shows a TCE in which the blower is replaced by converting the free piston/separator to a driven piston, and then using it to replace the blower;

FIG. 6 shows a TCE with refrigeration; and

FIG. 7 shows a TCE which uses high temperature fluid in the expander.

Corresponding reference numerals indicate corresponding parts throughout the several views of the drawings.

### DETAILED DESCRIPTION

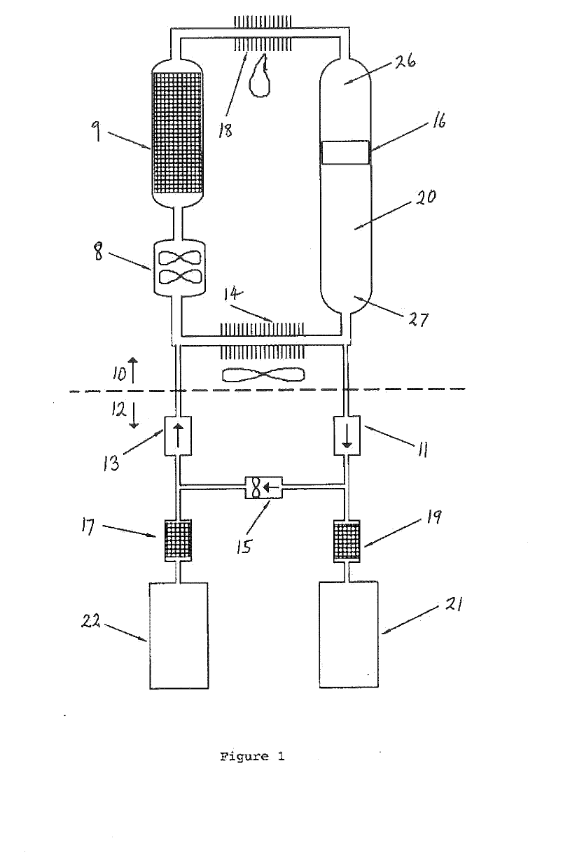

FIG. 1 shows a mechanical power producing thermodynamic cycle referred to as the TCE (Thermal Compression Engine) cycle. Cycle simulation and the predicted results are examined. The approach, implementation, and test results of a completed reduction to practice are supplied.

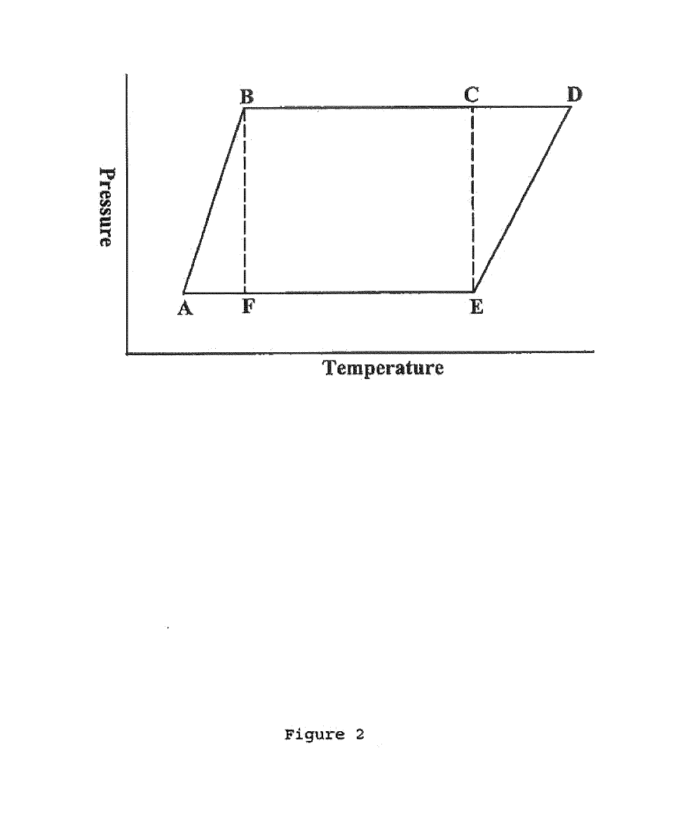

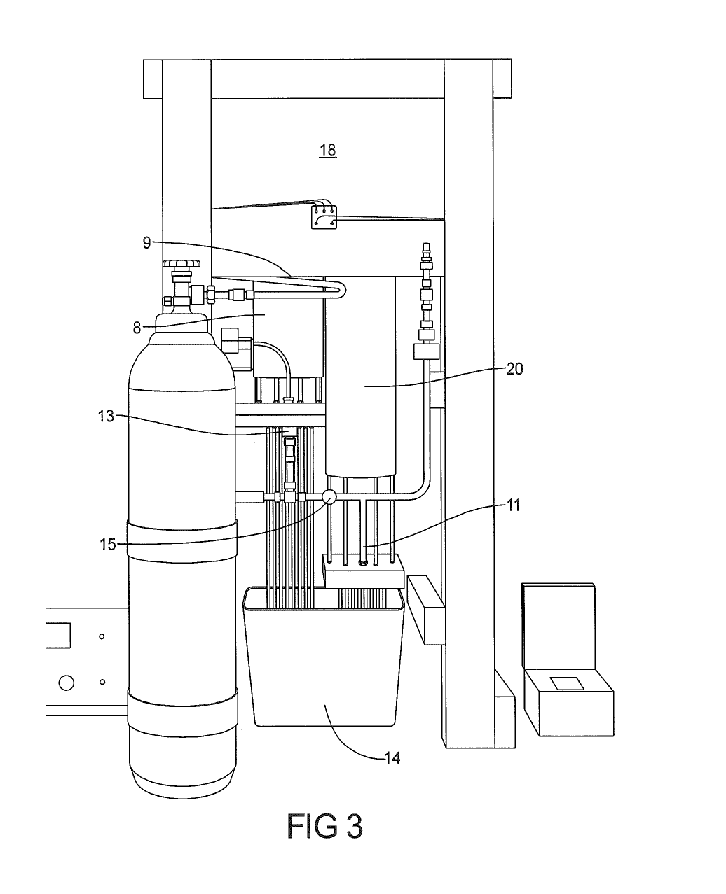

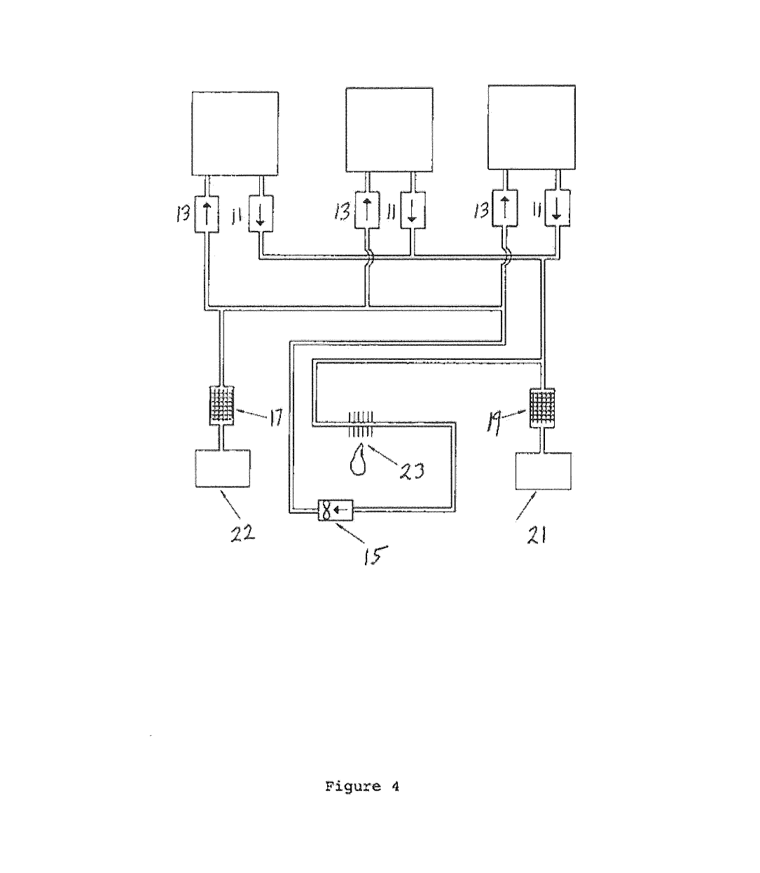

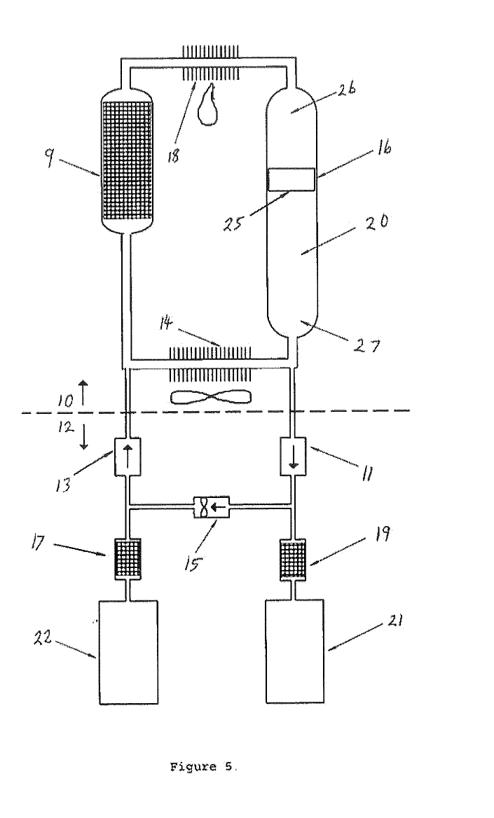

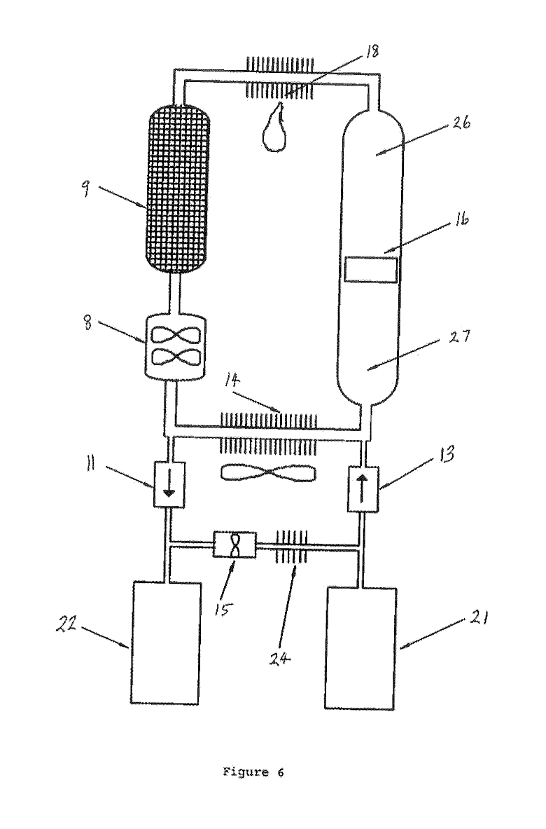

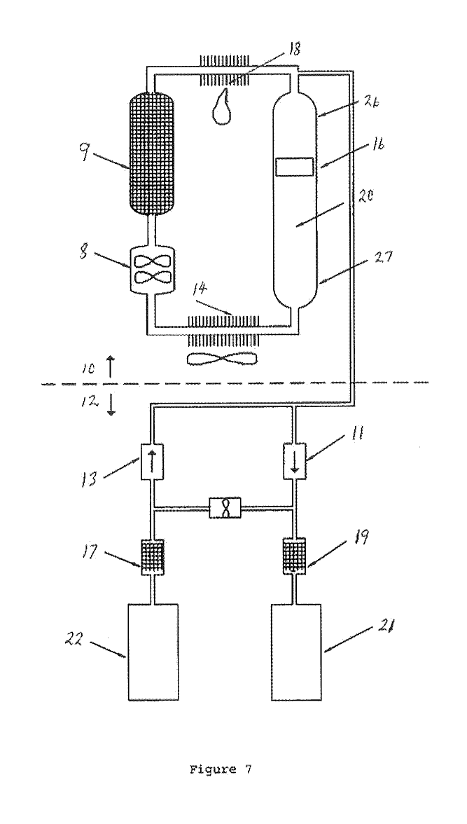

A baseline TCE configuration is described and explained with respect to FIGS. 1 and 2. Shown is the cycle analysis as an ideal cycle and a computer simulation of the cycle. FIG. 3 depicts the implementation of a proof of concept engine that was built and tested. FIG. 4 shows how multiple main loops can be combined to drive a single expander. FIG. 5 shows how the blower can be eliminated by driving what is normally the free piston. FIGS. 6 and 7 depict variations of the TCE cycle.

The TCE cycle is described in terms of a main loop 10 and an output loop 12. FIG. 1 shows the schematic of the baseline cycle. The figure is divided into the main loop 10 and the output loop 12 by a horizontal dashed line near the middle of the figure. Fluid in the main loop 10 is moved by the reversible blower 8. The case where the blower 8 is generating flow that travels from the blower 8 to the regenerator 9 (clockwise direction in the diagram) will be referred to as the forward direction.

When the blower flow is in the forward direction, low temperature fluid will enter the regenerator 9 from the cold side heat rejection exchanger 14 after passing through the blower 8. The fluid will pick up heat from the regenerator matrix 9. After passing through the regenerator matrix 9 the fluid is heated further in the heat input exchanger 18. The hot fluid then passes into the working volume 20 which moves the free piston/separator 16 down and displaces cold fluid from the bottom of the working volume 20 into the heat rejection exchanger 14 where it gives up heat. From the heat rejection exchanger 14 the fluid enters the blower 8, forming a complete loop in the forward direction. The free piston/separator 16 in the working volume 20 isolates the high temperature fluid above it from the lower temperature fluid below it. When the hot fluid fills the working volume 20 almost all of the fluid in the constant volume of the main loop 10, except the fluid which is in the dead volume, is at a high temperature and therefore the pressure in the main loop 10 is high. The volume in the main loop 10 that is not in the working volume 20 is referred to as dead volume. When the free piston/separator 16 reaches the lower free piston sensor 27 the blower 8 is reversed. At this point, referring to FIG. 1, the flow will start moving counter clockwise. This flow will be referred to as being in the reverse direction.

With flow now in the reverse direction, the fluid goes from the blower 8 into the heat rejection exchanger 14 where any excess temperature causes the fluid to give up heat. From the heat rejection exchanger 14, the low temperature fluid flows into the working volume 20 which moves the free piston/separator 16 up, and displaces the hot fluid above it from the working volume 20 into the heat input exchanger 18. When the cold fluid fills the working volume 20 almost all of the fluid in the constant volume of the main loop 10 is at a low temperature and therefore the pressure in the loop is low. The high temperature fluid displaced out of the working volume 20 passes through the heat input exchanger 18 and picks up heat. From the hot exchanger the hot fluid flows into the regenerator 9, where it gives up its heat to the regenerator matrix exiting the regenerator 9 at low temperature. From the regenerator 9 the low temperature fluid enters the blower 8 forming a complete loop in the reverse direction. When the free piston/separator 16 reaches the upper free piston sensor 26 the blower 8 is reversed and the forward flow cycle described above repeats.

Note that the entire main loop 10 is at basically the same pressure at any instant of time. The main loop 10 pressure rises and falls in all of the components in unison. The only difference in the pressures at various components results from the fluid flow, generated by the blower 8, through the components, and that pressure drop is very small. All the blower 8 has to do is move the fluid (and the free piston/separator 16); it does not have to do any compression of the fluid (other than the small amount required to get the fluid to move). The pressure drop through the components and the fluid velocity of the main loop 10 is kept low in order to keep the blower power low.

Now consider the output loop 12, which is below the dashed line in FIG. 1. When the main loop 10 is flowing in the forward direction, it will create a high pressure in the main loop 10 as described above. When the pressure in the main loop 10 rises above the pressure in the high pressure storage of the output loop, some of the fluid will leave the main loop 10 through the exit check valve 11. Some of this fluid will go into the high pressure storage 21, and some of it will go into and through the expander. The high pressure storage 21 is a relatively large volume in which fluid is stored at high pressure. The high pressure storage regenerator 19 (this regenerator is optional and helps reduce the temperature and heat loss in the high pressure storage 21) stores the heat of the fluid going into the high pressure storage 21 container and returns it to the fluid as the fluid leaves the container. The fluid flows through the expander and produces mechanical work output. The temperature of the fluid drops through the expander and goes into the low pressure storage 22. The low pressure storage 22 is a relatively large volume in which fluid is stored at low pressure. The low pressure storage regenerator 17 (this regenerator is optional and helps reduce the possibility that the low pressure storage 22 gets too hot) stores the heat of the fluid going into the low pressure storage 22 container and returns it to the fluid as the fluid leaves the container. This regenerator may not be required or desirable, and will need to be determined for individual applications.

When the main loop blower 8 reverses, the fluid starts flowing in the reverse direction in the main loop 10, and will create a low pressure. When pressure in the main loop 10 drops below the pressure of the low pressure storage 22, fluid will flow from the low pressure storage 22 and the expander exit back into the main loop 10 through the inlet check valve 13.

The expander 15 is used to allow high pressure fluid to expand to the low pressure and produce mechanical work output. It is expected that (at least for large systems) this expander 15 will be a turbine, so it is shown here to somewhat resemble an axial turbine. The flow capacity of the expander 15 can be set such that the pressure ratio across the expander 15 is at an optimum value. A small flow will mean a large pressure ratio with small flow extraction from the main loop 10. A large expander 15 flow capacity will mean a low pressure ratio and relatively large flow extractions from the main loop 10. There is an optimum pressure ratio based on various system parameters (mainly the absolute temperature ratio from the hot side to the cold side of the engine) at which the cycle efficiency is the highest. The high pressure storage 21 and low pressure storage 22 supply fluid to the expander 15 when there is no flow to or from the main loop 10. The size of the storage tanks is large enough to always supply flow to the expander 15 and to reduce the magnitude of pressure fluctuations across the expander 15.

The output power of the TCE cycle can be controlled by controlling the basic system pressure, or by controlling the main loop 10 cycle rate. The blower flow rate can be controlled by the speed of the blower 8, thus determining the rate the control system changes the direction of the blower 8, since it will take longer to purge the working volume 20 of either hot or cold fluid when the blower speed is low. The other approach is to keep the blower flow rate constant, but to simply stop the blower 8 for some time period between switching from the reverse direction to the forward direction.

The pressure in the main loop 10 during the “forward flow” (and during the “reverse flow”) into the main loop 10 can be basically the same in all the “main loop 10”: the “reversible blower” does not decouple the “hot” volume from the “cold” one.” The only pressure differential required in the main loop 10 of the engine can be to move the fluid around. The flow passages are all large and the flow velocity can be very low, so the pressure differentials required are very small and could be ignored in the computer simulation since they were so small that they had no significant effect on the simulation. This pressure can be the same in the entire main loop 10 can be one of the things that makes the concept so appealing, there can be no mechanical compression required. The compression can be being done by the thermal input and not by a mechanical compression process of the blower 8. The “free piston” only prevents mixing of the hot and cold fluids in the working volume 20, it does not cause compression. The engine does not depend on the pressure drops in the main loop 10; it actually can be hampered by the small pressure drops that are there. The reversible blower 8 has the ability to generate only enough pressure to move the fluid in the main loop 10 and cannot cause significant pressure differences in the main loop 10. Until the concept that all of the components in the main loop 10 are at essentially the same pressure, and that the pressure rises and falls in all of the components in the main loop 10 in unison can be understood the TCE cycle described above is not understood properly. The prototype was built and worked (producing more power that was input in the blower 8) without the “free piston”. The reason the free piston 16 is not required is due to the fact that the pressures in the entire main loop 10 is essentially the same, as described in the description of FIG. 1.

In order to understand the capabilities of the TCE cycle two approaches were taken. First, a simplified, idealistic cycle was considered. Second, a detailed computer simulation was created to aid in understanding the cycle and enabling the design of a proof of concept engine.

A pressure vs temperature curve seems to be most descriptive of the TCE cycle, shown figuratively in FIG. 2. Various points in the cycle are designated by capital letters from A to F. Absolute temperatures (T), absolute pressures (P), and mass (M) at these points will subsequently be referred to by using the subscript A to F with the variable name T, P, or M. Point A corresponds to the point in the cycle where all of the fluid in the working volume 20 is at the cold temperature condition (this condition occurs at the end of the reverse flow in the main loop 10). Point D corresponds to the point in the cycle where all of the fluid in the working volume 20 is at the high temperature condition (this condition occurs at the end of the forward flow in the main loop 10). Points A and D are the only points where all of the fluid in the main loop 10 is at the same condition, at the same time, in the TCE cycle. Based on the ideal gas laws, the conditions at A and D can be stated. V represents the working volume 20, and R the gas constant, in the following equations.

P_{A}×V=M_{A}×R×T_{A} (1)

P_{D}×V=M_{D}×R×T_{D} (2)

The points B, C, E, and F will be used as reference points and cannot be represented by a single condition in the working volume 20, since the fluid is at multiple conditions at these points.

We can eliminate R and V in equations (1) and (2) and solve for M_{A} (this result will be used later).

$${M}_{A} = {M}_{D} \times \frac{{T}_{D}}{{T}_{A}} \times \frac{{P}_{A}}{{P}_{D}} \qquad ( 3 )$$

Forward flow of fluid in the main loop 10 takes the cycle from point A to B to C and finally all of the fluid remaining in the main loop 10 to D. The fluid coming into the working volume 20 from the regenerator and heat input exchanger 18 is actually going from TA to TD, while at the same time some of the fluid that was already in the working volume 20 undergoes an isentropic compression by the rising pressure in the working volume 20. At some point the fluid in the working volume 20 reaches the pressure P_{D}, and this defines reference point B. From point B to C and on to point D, some of the fluid leaves the low temperature side of the working volume 20 at temperature T_{B} through the exit check valve 11 to the high pressure storage 21. The fluid that leaves the main loop 10 from point B to Point D will be referred to as M_{Out}. This is the flow that will go through the expander 15 in one cycle of the main loop 10, and gets converted to mechanical work. We see that:

M_{Out}=M_{A}−M_{D} (4)

Reverse flow of fluid in the main loop 10 takes the cycle from point D to E to F and finally back to A to complete the cycle. The fluid coming into the working volume 20 with this reverse flow from the heat rejection exchanger 14 is at temperature T_{A}, while at the same time, some of the fluid that was already in the working volume 20 undergoes an isentropic expansion by the dropping pressure in the working volume 20. At some point the fluid in the working volume 20 reaches the pressure P_{A}, and this defines reference point E. From point E to F and on to point A, some of the fluid enters the main loop 10 through the inlet check valve 13 from the low pressure storage 22. This fluid is at temperature T_{A} after going through the expander 15. If the temperature is not quite at T_{A}, the temperature will be changed to T_{A} by going through the heat rejection exchanger 14.

For later use consider the ideal gas properties for a reversible adiabatic process (where g is the ratio of specific heat)

$$\begin{matrix}{T}_{A} = {T}_{B} \times {( \frac{{P}_{D}}{{P}_{A}} )}^{( 1 - γ ) \text{/} γ} & ( 5 ) \\ {T}_{C} = {T}_{D} \times {( \frac{{P}_{D}}{{P}_{A}} )}^{( 1 - γ ) \text{/} γ} & ( 6 ) \\ {T}_{B} = {T}_{A} \times {( \frac{{P}_{D}}{{P}_{A}} )}^{( γ - 1 ) \text{/} γ} & ( 7 )\end{matrix}$$

These processes are oversimplifications of the actual processes and will be discussed below. The fluid that enters the output loop and passes through the expander 15 undergoes isentropic (ideal) expansion creates mechanical work (W_{Out}), where Cₚ is the constant pressure specific heat. The mass output by a single cycle of the main loop 10 is converted to a fluid flow by multiplying it by the number of cycles the main loop 10 makes per second (CPS).

W_{Out}=M_{Out}×CPS×Cₚ×(T_{B}−T_{A}) (8)

The heat given up to the regenerator by the fluid in going from point E to point F is adequate to take the fluid from point B to point C. The temperature rise from A to B is a result of the isentropic compression of the fluid. The temperature drop from D to E is a result of the isentropic expansion of the fluid. The only heat input (Q_{In}) required for the cycle then is to take the fluid from T_{C} to T_{D}.

Q_{In}=M_{D}×CPS×Cₚ×(T_{D}−T_{C}) (9)

Now by the definition of efficiency we have:

$$η = \frac{{W}_{Out}}{{Q}_{In}} \qquad ( 10 )$$

Substituting Eqn. (8) and Eqn. (9) into Eqn. (10) we get:

$${η}_{TCE} = \frac{{M}_{Out} \times CPS \times {C}_{P} \times ( {T}_{B} - {T}_{A} )}{{M}_{D} \times CPS \times {C}_{P} \times ( {T}_{D} - {T}_{C} )} \qquad ( 11 )$$

Which, after cancelling Cₚ and CPS, then using Eqn. (4) we get:

$${η}_{TCE} = \frac{{M}_{A} - {M}_{D}}{{M}_{D}} \times \frac{{T}_{B} - {T}_{A}}{{T}_{D} - {T}_{C}} \qquad ( 12 )$$

Now substituting equation (3) into equation (12) and canceling M_{D} and rearranging we get:

$${η}_{TCE} = \frac{{T}_{D} - {T}_{A} \times \frac{{P}_{D}}{{P}_{A}}}{{T}_{A} \times \frac{{P}_{D}}{{P}_{A}}} \times \frac{{T}_{B} - {T}_{A}}{{T}_{D} - {T}_{C}} \qquad ( 13 )$$

Now using Eqn. (5) and Eqn. (6) we can write

$${η}_{TCE} = \frac{{T}_{D} - {T}_{A} \times \frac{{P}_{D}}{{P}_{A}}}{{T}_{A} \times \frac{{P}_{D}}{{P}_{A}}} \times \frac{{T}_{B} - {T}_{B} \times {( \frac{{P}_{D}}{{P}_{A}} )}^{( 1 - γ ) \text{/} γ}}{{T}_{D} - {T}_{D} \times {( \frac{{P}_{D}}{{P}_{A}} )}^{( 1 - γ ) \text{/} γ}} \qquad ( 14 )$$

or factoring out T_{B} in the numerator and T_{D} in the denominator, in the second part of the equation, and then canceling out the (1−(P_{D}/P_{A})̂(1−γ)/γ) term we get

$${η}_{TCE} = \frac{{T}_{D} - {T}_{A} \times \frac{{P}_{D}}{{P}_{A}}}{{T}_{A} \times \frac{{P}_{D}}{{P}_{A}}} \times \frac{{T}_{B}}{{T}_{D}} \qquad ( 15 )$$

Now using (7) to replace T_{B} we get

$${η}_{TCE} = \frac{{T}_{D} - {T}_{A} \times \frac{{P}_{D}}{{P}_{A}}}{{T}_{A} \times \frac{{P}_{D}}{{P}_{A}}} \times \frac{{T}_{A} \times {( \frac{{P}_{D}}{{P}_{A}} )}^{( γ - 1 ) \text{/} γ}}{{T}_{D}} \qquad ( 16 )$$

With manipulation then the result is

$${η}_{TCE} = \frac{{T}_{D} - {T}_{A} \times \frac{{P}_{D}}{{P}_{A}}}{{T}_{D} \times {( \frac{{P}_{D}}{{P}_{A}} )}^{1 \text{/} γ}} \qquad ( 17 )$$

This is not the Carnot efficiency. The Carnot efficiency would be:

$${η}_{Carnot} = \frac{{T}_{D} - {T}_{A}}{{T}_{D}} \qquad ( 18 )$$

It can be seen that the efficiency of the TCE cycle approaches that of the Carnot cycle as the pressure ratio between the high and low pressures approaches 1 (if the fluid is gas). The optimum pressure ratio for a real machine needs to be established by computer simulation and/or engine testing where all of the losses and dead volume in the system are considered. A pressure ratio between 1.1 and 1.4 is probably a realistic value for optimum efficiency.

One thing that normally makes the ideal cycle analysis simple is that it is assumed all of the fluid goes through the same process at the same time, and moves from one process to the next. This is not the case for the TCE cycle. As the blower 8 starts the fluid flowing in the forward direction the fluid entering the working volume 20 is raised in temperature to the temperature of the heat source (ideal case) and therefore expands, meanwhile the fluid in the working volume 20 is being compressed by the incoming, expanding fluid. As the hot fluid is still entering the working volume 20, and before the high pressure (set by the check valve and the pressure of the high pressure storage 21) is reached some of the hot fluid has already entered the working volume 20. This hot gas is now being compressed as the pressure rises in the working volume 20, resulting in the temperature of that amount of fluid actually rising above the temperature it achieved in the heat input exchanger 18. A similar situation occurs due to expansion during flow in the reverse direction. This results in more output fluid flow than assumed by the ideal analysis above.

Because these, and other, effects are not included in the ideal analysis it is felt that the ideal analysis is pessimistic in terms of the efficiency reduction for larger pressure ratios. It is felt that a better ideal analysis might show that the efficiency is closer to the Carnot efficiency even for larger pressure ratios. There really is nothing steady state about the TCE cycle. Many different processes are going on at the same time. It was decided that the proper approach for the simulation was to create a dynamic computer model that would reach steady state operation, after executing for some period of time, through multiple complete cycles of the main loop 10. The simulation could then be used to predict and help understand the cycle capabilities. The simulation was useful in the design of a proof of concept engine.

The basic approach taken to the dynamic simulation was to use small time steps and ensure conservation of mass and energy for each of the time steps, in all of the components of the engine. A Newton-Raphson iteration technique was used to converge each time step. Time steps of 1 millisecond in size were used for the simulation.

In any simulation, simplifying assumptions must be made in order to keep the level of complexity reasonable while not missing any of the important factors. One of the assumptions that was possible in the case of the TCE cycle was the assumption that the entire main loop 10 pressure was the same everywhere in the main loop 10 at any instant of time. This was possible because the blower 8, as indicated before, only moves the fluid around and does not create any significant pressure rise. The second thing that made the constant pressure assumption throughout the loop reasonable was the fact that the blower 8 reversal happens at a slow rate of about one second forward and one second in reverse for the proof of concept engine. The fluid velocity (for the proof of concept engine) at that condition is about 2 ft per second in the working volume 20 of the main loop 10. The momentum of the fluid could therefore be ignored without too much effect. The motor and blower 8 inertia were considered, and dominated the fluid momentum. The simulation took significant computer time, in most cases twelve or more hours, until equilibrium was approached for a given set of conditions. Approximations are used for the blower 8 including flow being a function of RPM, delta temperature being a function of speed squared, and a time constant to account for the combined fluid and motor inertia.

Fluid flow in the simulation is tracked as flow rates between components. In the regenerator, however, the flow rate is converted to a mass of fluid that flows during a single time step into the regenerator. This mass of fluid is then tracked through the regenerator as a unit, through as many time-steps as required, until the mass exits the regenerator and gets converted back to a flow. Multiple units (approximately 2000 units in the current simulation) of fluid mass are in the regenerator, at different locations, at any given time step. Based on the conditions (pressure and temperature) of the fluid within a section of the regenerator, the volume of regenerator that the unit of fluid takes up is calculated, and the heat transfer with the regenerator matrix at that location is calculated. The matrix itself is broken up into as many segments as there are screens in the regenerator.

It was assumed that the hot exchanger heat source would supply whatever quantity of heat required producing the desired high temperature. The working volume 20 is handled in a fashion similar to the regenerator except that the heat transfer with the matrix does not need to be calculated. It was assumed that the cold exchanger can reject whatever quantity of heat rejection required producing the desired cold temperature.

The inlet and exit check valves are simulated as having no leakage. The pressure drop in the forward direction was calculated based on an equivalent area through the valve. The storage tanks are simulated using the fluid properties and the effects of the rising and lowering pressure to determine the amount of mass the storage tank could contain, and therefore, what the flow in or out of the container would be. The fluid in the storage tanks was assumed to be completely mixed.

The turbine was simulated in a basic fashion by using the inlet pressure, exit pressure, inlet temperature, flow area, fluid properties, and assumed efficiency. The use of a constant flow area resembled the case of an impingement turbine. No attempt was made to use an actual turbine map.

Once the computer simulation was completed, different studies were performed to determine the characteristics of the TCE for various applications and to optimize the hardware approach for the proof of concept engine. The results of these simulations suggested that the TCE cycle could achieve efficiencies very near to that of the Carnot cycle. This agreed with the results of the ideal analysis in the previous section. If the losses are kept low enough, the simulation would actually predict better efficiencies than was shown by the ideal analysis for the TCE, but not better than the Carnot cycle.

The proof of concept test engine configuration was determined mostly by two things. The first was an attempt to build a test model that would show if the TCE approach was viable. The second determining factor in the proof of concept engine configuration was the ability to build it with simple tools and a limited budget. The proof of concept engine was implemented without the free piston separator. This results in the undesirable mixing of the hot and cold fluid in the working volume 20. Individual components of the proof of concept engine will now be described.

While the blower 8 consists of two reversible counter rotating axial elements that are driven by two separate electric motors. It should be understood any suitable blower is useable. The regenerator 9 for the proof of concept engine was formed using woven stainless steel bolting cloth with a 40×40 mesh and 0.0065 inch diameter wire. This is a very open mesh compared to that often used in Sterling engines. Sufficient matrix material was obtained by making the regenerator about 3.50 inches long.

It was found that the smallest tubing that could be expanded by means of a tube expanding roller was ¼ inch in diameter. This was therefore the diameter that was selected for the heat exchanger tubing. The use of the larger diameter tubes increased the undesirable dead volume in the proof of concept unit, and resulted in less than optimum surface area for heat transfer.

The heating elements for the hot end are two hot air heat gun elements that were rated at 1600 watts each (with the gun blower blowing air over them). For this proof of concept application there was no forced air flow over the heating elements. Only natural convection was used to circulate the heated air. The short tubes in the heat exchanger are significantly shorter than the long tubes. The tubes are not heated evenly with the heating elements, which is undesirable, especially since there was no free piston/separator

The working volume 20 consists of a schedule 10 seam welded stainless steel pipe that can be 24 inches long. The inside of the pipe was lined with a sheet of mica in order to reduce the heat transfer between the fluid and the pipe wall. As indicated above, the demo engine was constructed without a free piston/separator in the working volume 20. The upper 26 and lower 27 temperature sensors are chromel alumel thermocouples. Butt welded thermocouples (0.010 in. diam.) are located in the working volume 20 by stretching the wire from one side of the pipe to the other and held in place by ceramic insulators. The thermocouples are located 3 inches from each end of the working volume 20. When the lower thermocouple temperature 27 started to rise, it signaled the control system to switch the blower 8 into the reverse flow direction. Similarly when the upper thermocouple temperature 26 started dropping, it signaled the control system to switch the blower 8 into the forward flow direction.

The check valves for the proof of concept engine are off the shelf check valves with a 6.9 kPa (1 psid) spring holding them closed. They are sized for ⅜ inch connections. The cold end heat exchanger can be made of tubes basically the same as the hot end. The tubes are longer on one side to allow them to meet up with the bottom end of the blower 8. The cold end tubes are submerged in water contained in a black plastic container, where the competed unit can be mounted in a test stand. As can be seen in FIG. 3, the entire length of the cold exchanger tubes are not submerged in water.

The electrical connections for the blower power, and the thermocouples at each end of the working volume 20, come through a pipe plug and are sealed with epoxy. A physical turbine was not used for the proof of concept engine, with the performance being measured as gas horsepower. The turbine pressure drop was simulated by a metering valve, for which the manufacturer supplied a flow curve as a function of setting. This data was converted to equivalent orifice areas, which were then used to calculate flow based on fluid characteristics, temperature and pressures. The temperature drop that would normally occur through the turbine was not simulated. The gas was reintroduced into the main loop 10 of the cycle at a temperature that was higher than it should be. It was felt that this was acceptable since the fluid would next go through the cold exchanger and give up its heat anyway, therefore not requiring a separate exchanger to extract the heat that the turbine normally would. This configuration was simulated with the computer simulation and it indicated only a slight penalty in overall efficiency for this higher temperature coming from the turbine.

The system fluid chosen for the proof of concept unit test was argon gas at about 2.76 Mpa (400 psia) to 3.45 MPa (500 psia). The complete unit, as tested, can be seen in FIG. 3. The unit has the insulation on the hot end (at the top) and can be mounted in a fixture. The cold exchanger extends into a container which was filled with ice and water.

A DAQ (data acquisition device) was used for obtaining data from the hardware and to control the proof of concept engine. The DAQ had 8 differential inputs and 8 digital inputs or outputs and communicates with the PC (personal computer) using a USB (Universal Serial Bus) connection. The DAQ was used to measure pressure into and out of the turbine (metering valve), turbine inlet temperature, working volume 20 hot and cold end temperatures, heater voltage and amperage, and hot end temperature. The flow valve setting, blower motor voltage, and amperage data was manually entered into the PC (adding more channels of analog input would have been more expensive than the budget allowed). The DAQ data was transferred to a PC using the USB connection.

The computer displayed the data and logged all of the received data into a data file for later viewing and analysis. The data was used to calculate the system performance as the test was under way, so the results could be seen immediately. The DAQ was used to generate the digital output signal for a relay to drive the blower 8 motor in a forward or reverse direction, based on the temperatures at the ends of the working volume 20. The DAQ also generated a digital output to control a solid state relay to maintain the hot end temperature at the desired value, as defined by a user input into the PC. The DAQ data was processed and the control functions performed at a 50 HZ rate.

Table 1 shows the test results obtained. The data for the demo test is shown in one column and the data for the simulation is shown in the next column. In Tab. 1 the efficiency is derived assuming actual blower power and an ideal expander 15 (gas power). The same test data will be shown in Table 2 (line 1) assuming an 88% efficient expander 15.

The efficiency numbers obtained are low. Some of this low efficiency can be the result of heat loss at the high temperature heat exchanger to ambient. This loss can be estimated to be about 369 watts (at the conditions in Table 2) based on heat loss without the blower 8 operating.

There are, however, some more basic reasons for the low efficiency of the proof of concept engine. It is believed that most of the low efficiency is the result of mixing of the hot end fluid and the cold end fluid in the working volume 20. The solution for this can be the free piston/separator that is in the baseline engine description, but was not implemented in the proof of concept engine. This is believed to be the major difference between the demo test results and of the simulation result. Other reasons for the low efficiency are easily identified. It is believed that the feasibility of the basic concept has been verified, which was the major intent of the proof of concept engine to begin with. Showing a better efficiency would have been nice, but not really necessary to prove out the basic concept.

The computer simulation was adjusted to meet the “as built” configuration. These adjustments included matching the dead volumes, and adjusting heat losses. The one thing that was not included in the simulation was the mixing that would occur due to the lack of a free piston/separator in the working volume 20. The test result compared to the simulation results at this point are shown in Table 1.

TABLE 1

| Parameter | Demo | Simulation |
|---|---|---|
| Heat Input Exchanger Temp | 177° C. (351° F.) | 177° C. (351° F.) |
| Heat Rejection Exchanger Temp | 0.0° C. (32° F.) | 0.0° C. (32° F.) |
| Watts of Heat Input | 1095 watts | 683 watts |
| Blower Watts Input | 22.75 watts | 22.37 watts |
| Blower Forward Direction | 1.42 sec | 1.42 sec |
| Blower Reverse Direction | 1.63 sec | 1.63 sec |
| Turbine (valve) Inlet Temp | 46° C. (115° F.) | 30° C. (86° F.) |
| Turbine (valve) Inlet Pressure | 3.43 Mpa | 3.43 MPa |
| | (497 psia) | (497 psia) |
| Turbine (valve) Pressure Ratio | 1.17 | 1.175 |
| Turbine (valve) Argon Flow | 7.03 g/sec | 8.39 g/sec |
| | 0.0155 lb/sec) | (0.0185 lb/sec) |
| Gas Power (ideal turbine) | 71 watts | 82.6 watts |
| Net Power (Gas Power-Blower) | 48.25 watts | 60.27 watts |
| Efficiency (Net power/heat Input) | 4.41% | 8.90% |

Table 2 shows the improvements that could be made to improve the performance of the proof of concept engine. All of the efficiencies in Table 2 are shown assuming a realistic blower 8 (based on test and simulation) and assuming an expander efficiency of 88%. The performance of the proof of concept engine is on line 1 of Table 2 and the simulation result for the same condition is on line 2 of Table 2. The performance of the proof of concept engine is expected to go from the tested performance of line 1 to the simulated performance shown in line 2 when the free piston/separator can be added.

TABLE 2

| | | TCE | |
|---|---|---|---|
| | Power | Simulation | |
| Configuration | Density | Predicted | Carnot |
| (88% Expander Effic) | kw/m3 | Effic % | Effic % |
| 1) Demo engine (Test Data) | 3.04 | 3.63 | 35.8 |
| 2) Sim of demo test (no mixing) | 3.89 | 7.45 | 35.8 |
| 3) Reduce heat loss of Hot end to | 3.89 | 13.16 | 35.8 |
| 20% | | | |
| 4) dead volume 33% of demo | 7.07 | 17.28 | 35.8 |
| 5) System press 2.96 MPa (430 psia) | 45 | 20.41 | 35.8 |
| to 14.82 MPa (2150 psia) | | | |
| 6) 6) High temp 177° C. (351° F.) to | 115.79 | 40.78 | 53.7 |
| 350° C. (662° F.) | | | |
| 7) High temp 350° C. (662° F.) to | 200 | 59.91 | 75.4 |
| 900° C. (1652° F.) | | | |
| 8) Cycle rate 3 sec/cyc to 1.5 s/c | 387.92 | 58.1 | 75.4 |

From line 2 to the end of Table 2, various improvements are incorporated in the simulation in an additive fashion. All of the improvements that are incorporated seem to be very feasible. Line 3 assumes that the heat loss at the hot end of the TCE could be improved so that the loss is only 20% of the loss found in the test data. Line 4 assumes that the dead volume in the engine could be reduced to be 33% of that existing in the test engine. Line 5 assumes that the system pressure would be raised from 2.96 MPa (430 psia) to 14.82 MPa (2150 psia). Line 6 assumes that the high temperature heat input exchanger 18 would operate at 350° C. (662° F.) instead of 177° C. (351° F.). Line 7 assumes that that high temperature would be further raised to 900° C. (1652° F.). Line 8 assumes that the cycle rate of the blower 8 was increased from 3 sec/cycle to 1.5 sec/cycle.

There are still losses that are not accounted for by the simulation, so it is not expected that a real engine will necessarily be able to meet the performance expressed in Table 2. Some of these losses include the heat transfer through some of the structure. This includes the heat transfer to and from the surface of the working volume 20 container. These types of losses need to be included in the simulation, but are not expected to have a drastic effect on the performance. Power Density in Table 2 is based on a volume for the entire TCE being assumed to be 3 times the working volume 20.

There are a number of different ways of implementing the TCE cycle. Individual components and different approaches to their implementation will now be described. The choice of the working fluid used in the TCE cycle needs more study and the final selection needs to be made on the requirements of a specific application. The advantage of low molecular weight fluids such as hydrogen and helium is that they require less energy to move them around in the main loop 10. The heat exchangers for these fluids can be made smaller and the dead volumes in the main loop 10 can be reduced. If a dynamic blower 8 and a dynamic expander 15 (turbine) are used a high molecular weight gas such as argon has the advantage that the mechanical speeds of the dynamic components will be lower. It appears that it might be desirable to use a fluid that is not an ideal gas.

A fluid that might work well with the TCE cycle is supercritical CO2. The advantage of this fluid is that the density difference between high and low temperature supercritical CO2 is larger than for an ideal gas for a given pressure and temperature difference. This means that a small temperature change can do the thermal compression, and then the rest of the available temperature change can be used to generate high pressure output gas, improving the power density of the engine. The performance of the regenerator needs to be evaluated with the supercritical CO2 to see if it can still be as effective as it can be for an ideal gas. Two phase fluids might also be considered for the TCE. One of the things that should be noted is that, since the TCE cycle does not have a mechanical compression process, the TCE could be implemented using a fluid that is, and remains, a liquid for the entire cycle. The high pressure 21 and low pressure storage 22 containers must then be hydraulic accumulators rather than just containers in which a gas is compressed.

As shown in FIG. 4, the system can optionally have multiple main loops 10. The control system can synchronize the multiple loops so there can be a phase difference in each main loop 10 cycle. This ensures there can be always one main loop 10 producing high pressure fluid while there can be another main loop 10 with fluid returning from the low pressure side of the expander 15. This means that the high and low pressure storage 21, 22 can be greatly reduced in size, or even eliminated. The ability of having multiple main loop 10s might have some real advantages to reduce cost. For example, a solar installation might have many main loop 10s all feeding high pressure fluid to a single output loop. FIG. 4 shows an additional heat input exchanger 23, which is optional, and will be discussed later.

The free piston/separator 16 eliminates mixing of the hot end and cold fluid as well as reducing the heat transfer from hot to cold side. This piston 16 does not have to have a perfect seal, a labyrinth or a brush seal should be adequate. The piston 16 should be light weight or even hollow so that it is buoyant (or close to buoyant) in the cold fluid and sinks in the hot. Possibly the most desirable approach would be to completely eliminate the free piston 16. This approach was used for the proof of concept engine that was built and tested. This approach requires that the flow into and out of the working volume 20 as well as the temperature distribution can be as uniform as possible so that there is little mixing of the hot and cold fluid in the working volume 20. By the use of CFD (computational fluid dynamics) flow analysis and/or testing it may be possible to keep the mixing at acceptable levels. For stationary applications gravity can help eliminate the mixing, since the cold fluid will tend to want to stay at the bottom due to its density. This is similar to the way that the cold and hot water are separated in most home hot water heaters.

The blower 8 for the baseline TCE could be a dynamic blower 8 such as centrifugal or axial kinetic blower 8. It is required that the blower 8 transfer fluid in forward and reverse direction. The fluid could, of course, also be moved by a positive displacement device, rather than a dynamic blower 8. A number of positive displacement type of pumping devices come to mind, such as a roots blower 8, vane pump, scroll pump, etc.

It is possible to eliminate the need for a blower 8 completely and also replace the free piston 16 using a true piston 16 that can be sealed against the working volume 20 walls. This configuration in schematic form is shown in FIG. 5 with the blower 8 eliminated and replaced with a direct connection between the heat rejection exchanger 14 and the regenerator 9. The driven piston 16, in the working volume 20, replaces the blower 8 in transferring fluid in the forward and reverse direction (no compression). Although a suitable replacement, one of the difficulties with a driven piston 16 can be that moving the piston 16 presents some mechanical difficulties. A means must be provided for a mechanical means of driving 25 the driven piston 16. A crank type of mechanism would tend to be bulky and possibly create sealing difficulties of the high pressure main loop 10 if a seal is required by the mechanism because part of it is outside the main loop 10. It might be better to use a linear electric motor, a rack and pinion system, or other means, to move the piston 16.

The simulation of the TCE cycle and the reduction to practice of the engine it has become clear that certain things must be given strong consideration. This includes: 1. working volume 20 determines the amount of output produced per cycle of the main loop 10. Minimizing the dead volume in the main loop 10 can be very important; 2. Control system must take the information from the upper 26 and lower 27 sensors in the working volume 20 and create the optimum switching points for the blower 8; 3. Cycle time of the blower 8 (established by controlling the rate at which the working volume 20 can be filled and emptied of fluid) can be used to modulate power output of the TCE; 4. The expander choice depends very much on the requirements for any given design. Positive displacement expanders are probably the correct choice for small systems. For high capacity systems a turbine expander 15 can be the correct choice; 5. Check Valves must have low pressure drop in the forward direction and need to operate rapidly enough to avoid reducing cycle efficiencies. It may be desirable to use multiple small devices rather than a single large check valve to achieve rapid operation; 6. Expander should probably drive an alternator, which can be inside the working fluid, with only wires exiting the engine, in order to avoid fluid leakage problems; and 7. Regenerator needs to offer as little flow restriction as possible while supplying enough heat storage capacity for the fluid in the working volume 20.

The TCE cycle performs best with a high temperature heat source for heat input through the heat input exchanger 18. If there is an additional low temperature heat source available that has a temperature higher than the exit temperature of the fluid from the main loop 10, that heat can be used by the TCE cycle to increase the total output of the cycle. This additional heat input exchanger 23 is shown in FIG. 4 in conjunction with using multiple main loops as discussed before. (It should be noted that the additional heat input can also be accomplished if there is only one main loop, by placing the heat exchanger 23 just prior to the expander 15.) This secondary, low temperature heat source might be waste heat from the creation of the high temperature heat source, or it might be from some other source entirely. To implement this, a heat exchanger 23 can be added just prior to the expander 15. The low grade heat can be put into this exchanger, raising the temperature of the fluid going to the expander 15, and increasing the work output from the expander 15.

When using the additional heat input exchanger 23 there are two different efficiencies. One can be the normal TCE cycle efficiency which has been described above, the second efficiency can be the efficiency with which the additional low temperature heat can be used. The efficiency the low temperature heat can be used will not be as high as that of the high temperature heat, but that may not matter so much if that heat would otherwise be lost.

The TCE cycle baseline cycle can be modified to generate refrigeration while at the same time generating mechanical power. As shown in FIG. 6, the TCE cycle with refrigeration can be the same as the baseline cycle as seen in FIG. 1, except that the exit and inlet valves for the output loop are reversed. The exit valve can be attached between the blower 8 and the heat rejection exchanger 14, and the inlet valve can be attached between the heat rejection exchanger 14 and the working volume 20. The bleed from the main loop 10 occurs at the temperature of the cold side heat rejection and the temperature can be then dropped below cold side temperature by flowing through the expander 15 and doing work. After flowing through the expander 15 the fluid flows through a refrigeration heat exchanger 24 (added for the refrigeration cycle) and absorbs heat, thus supplying cooling. This may be a very useful feature for some applications.

The baseline cycle has low temperature gas that passes through the expander 15. Optionally, as shown in FIG. 7, the cycle can be implemented using high temperature fluid in the output loop. The TCE cycle with high temperature fluid output can be the same as the baseline cycle as seen in FIG. 1, except that the exit and inlet valves for the output loop are both attached between the high temperature input exchanger and the working volume 20. The operation of this high temperature output version can be basically the same as the one described for the low temperature version (baseline version) except that the fluid can be removed and returned to the main loop 10 at different locations. The requirement of using high temperature check valves and expander 15 makes this version more difficult to implement.

It should be noted that for the high temperature output cycle the fluid leaves the main loop 10 at a high temperature and must be returned to the main loop 10 at as close to the exit temperature from the expander 15 as possible, or else the efficiency will be detrimentally affected. The advantage of the high temperature version may be mostly in the power density improvement.

The cycle may be suitable for any application in which an external combustion engine can be used. The most likely applications for the TCE concept may be for waste heat energy recovery, solar thermal energy, nuclear power, and space based power systems. With an efficient external burner, the engine could of course burn any combustible material such as hydrocarbons or garbage. Since it appears that the TCE might be implemented inexpensively, it could open up new applications.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. The fluid in the thermal compression engine can consist of any gas, including gases that have a phase change. The engine can also be implemented using a fluid that remains a liquid for the entire cycle by replacing the high pressure and low pressure storage vessels with hydraulic accumulators.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other

\numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “bottom”, “above”, “upper”, “top” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Nomenclature Abbreviations: TCE Thermal Compression Engine; Symbols; CPS Cycles per second of main loop 10, M Mass (flow in one main loop 10 cycle), M_{Out} Mass going through expander 15, P Pressure, Q_{In} Heat flow into TCE cycle, R Gas constant, T Absolute temperature, V Volume, W_{Out} Mechanical work output from expander 15, g Ratio of specific heat, η_{Carnot} Efficiency of Carnot cycle, η_{TCE} Ideal efficiency of TCE cycle; Subscripts (points in TCE cycle, see FIG. 2) A Working volume filled with low temp fluid, B Fluid has undergone isentropic compression, C Fluid has been heated by regenerator, D Working volume filled with high temp fluid, E Fluid has undergone isentropic expansion, and F Fluid has been cooled by regenerator.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A thermal compression engine comprising:
a main loop fluidly coupling a heat input exchanger, a vessel defining a working volume, a heat rejection exchanger, a regenerator configured to store heat, and a method of creating forward and reverse fluid flow in the main loop; and
an output loop, the output loop having a first passage fluidly coupled to the main loop through a first check valve being fluidly coupled to a second vessel defining a high pressure storage, and a expander, the expander being coupled to a third vessel defining a low pressure storage, the third vessel being coupled to an second check valve which is fluidly coupled to the main loop through a second passage.

2. The thermal compression engine according to claim 1 wherein a second regenerator is incorporated prior to the second vessel defining a high pressure storage.

3. The thermal compression engine according to claim 1 wherein a third regenerator is incorporated prior to the third vessel defining a low pressure storage.

4. The thermal compression engine according to claim 1 wherein the first passage is disposed on a first heat rejection exchanger side (the side nearest the working volume) and the second passage is disposed on the second heat rejection exchanger side.

5. The thermal compression engine according to claim 1 wherein the second passage is disposed on a first heat rejection exchanger side (the side nearest the working volume) and the first passage is disposed on the second heat rejection exchanger side, a heat exchanger can then be inserted after the expander in order to get refrigeration.

6. The thermal compression engine according to claim 1 wherein the first passage and second passage are disposed between the heat input exchanger and the working volume

7. The thermal compression engine according to claim 1 wherein the fluid in the thermal compression engine can consist of any gas, including gases that have a phase change. The engine can also be implemented using a fluid that remains a liquid for the entire cycle by replacing the high pressure and low pressure storage vessels with hydraulic accumulators.

8. The thermal compression engine according to claim 1 wherein the TCE can be implemented in a form which allows additional low temperature heat input.

9. The thermal compression engine according to claim 1 further comprising a free piston separator disposed in the working volume.

10. The thermal compression engine according to claim 1 wherein the expander is configured to allow high pressure fluid to expand to the low pressure and produce mechanical work output.

11. The thermal compression engine according to claim 1 wherein Multiple main loops are be connected together with check valves to all feed into one expander, when this is done the volume in the second and third storage vessels can be reduced.

12. The thermal compression engine according to claim 1 wherein gas from the main loop is extracted at a plurality of locations.

13. A thermal compression engine comprising:
a first loop fluidly coupling a heat input exchanger directly coupled to a vessel defining a working volume which is coupled to a heat rejection exchanger which is coupled to a regenerator configured to store heat, disposed within the first loop is a means for creating forward and reverse fluid flow in the first loop; and
an output loop, the output loop having a first passage fluidly coupled to the main loop through a first check valve being fluidly coupled to a second vessel defining a first pressure storage, and a expander, the expander being coupled to a third vessel defining a second pressure storage, the third vessel being coupled to an second check valve which is fluidly coupled to the main loop through a second passage.

14. The thermal compression engine according to claim 13 wherein a second regenerator is incorporated prior to the second vessel defining a second pressure storage.

15. The thermal compression engine according to claim 13 wherein a third regenerator is incorporated prior to the third vessel defining a first pressure storage.

16. The thermal compression engine according to claim 13 wherein the first passage is disposed on a first heat rejection exchanger side and the second passage is disposed on a second heat rejection exchanger side.

17. The thermal compression engine according to claim 13 wherein the second passage is disposed on a first heat rejection exchanger side and the first passage is disposed on the second heat rejection exchanger side, a heat exchanger can then be inserted after the expander in order to get refrigeration.

18. The thermal compression engine according to claim 13 wherein the first passage and second passage are disposed between the heat input exchanger and the working volume.

19. The thermal compression engine according to claim 13 wherein the fluid in the thermal compression engine can consist of any gas, including gases that have a phase change. The engine can also be implemented using a fluid that remains a liquid for the entire cycle by replacing the high pressure and low pressure storage vessels with hydraulic accumulators.

20. The thermal compression engine according to claim 13 wherein the TCE can be implemented in a form which allows additional low temperature heat input.
